(19) United States
(12) Patent Application Publication
(10) Pub. No.: US 2006/0106638 A1
(43) Pub. Date: May 18, 2006

(54) System and method for defining occupational-specific skills associated with job posistions

(75) Inventors: Michael L. Brown, Waxahachie, TX (US); Darrel L. Sandall, Grandview, TX (US); Robert J. Landis, Midlothian, TX (US)

Correspondence Address: RG & Associates, 1103 Twin Creeks, Allen, TX, 75013, US

(73) Assignee: SkillsNET Corporation, Waxahachie, TX (US)

(21) Appl. No.: 11/323,523

(22) Filed: Dec. 30, 2005

Related U.S. Application Data
(63) Continuation of application No. 11/127,758, filed on May 12, 2005.
(60) Provisional application No. 60/570,947, filed on May 13, 2004.

(51) Int. Cl. G06Q 99/00; G05B 19/418; G06F 15/02

(52) U.S. Cl. 705/1; 705/8; 705/9

(57) ABSTRACT

A method includes identifying a plurality of tasks associated with at least one type of work. The method also includes grouping the plurality of tasks into one or more groups. Each group includes at least one of the identified tasks. The method further includes identifying, for each of the one or more groups, at least one additional characteristic associated with the group. In addition, the method includes storing, for each of the one or more groups, information identifying the at least one task associated with the group and the at least one additional characteristic associated with the group in a data object.

### CROSS-REFERENCE TO RELATED APPLICATIONS

The present invention is a continuation of and claims priority from U.S. Non-Provisional patent application Ser. No. 11/127,758, filed on May 12, 2005 which claims priority from U.S. Provisional Patent Application 60/570,947 filed on May 13, 2004. The present invention is also related to patent application docket number SN-SO3 filed on even date herewith. The entire contents of each of the applications are enclosed by reference herein in their entirety.

### TECHNICAL FIELD

This disclosure relates generally to human resource management systems and more specifically to a system and method for defining occupational-specific skills associated with job positions.

### BACKGROUND

Employers often perform various tasks involving an analysis of the skills associated with various job positions. For example, the employers often need to determine which particular occupational-specific skills are important for completing a project or meeting performance quotas. The employers also typically offer training to improve particular occupational-specific skills of their employees. In addition, the employers typically need to interview job applicants and determine whether the applicants possess the skills required for particular job openings.

A problem facing many employers is that it is often difficult and time consuming to perform these tasks and to identify, validate, and maintain an occupational-specific skills inventory. For example, employers often perform surveys to identify the skills used in different job positions, the skills needed for a particular project, or the skills needing improvement through training. These surveys often take lengthy amounts of time to complete and produce large quantities of data that are difficult to analyze.

### SUMMARY

This disclosure provides an improved system and method for defining occupational-specific skills associated with job positions.

In a first embodiment, a method includes identifying a plurality of tasks associated with at least one job position. The method also includes grouping the plurality of tasks into one or more groups. Each group includes at least one of the identified tasks. The method further includes identifying, for each of the one or more groups, at least one additional characteristic associated with the group. In addition, the method includes storing, for each of the one or more groups, information identifying the at least one task associated with the group and the at least one additional characteristic associated with the group in a data object.

In particular embodiments, the data objects are used to determine if a job applicant is qualified for a job position, identify training for at least one employee, or identify one or more job positions or occupations for which a job applicant is qualified.

In a second embodiment, a system includes a memory operable to store one or more data objects. The system also includes one or more processors collectively operable to store information identifying a group of tasks associated with at least one job position in each of the data objects. Each group includes at least one task. The one or more processors are also collectively operable to store information identifying at least one additional characteristic associated with the group of tasks in each of the data objects.

In a third embodiment, a computer program is embodied on a computer readable medium and is operable to be executed by a processor. The computer program includes computer readable program code for receiving an identification of one or more groups of tasks associated with at least one job position. Each group includes at least one task. The computer program also includes computer readable program code for receiving, for each of the one or more groups, an identification of at least one additional characteristic associated with the group. In addition, the computer program includes computer readable program code for storing, for each of the one or more groups, information identifying the at least one task and the at least one additional characteristic associated with the group in a data object.

In a fourth embodiment, a computer readable medium is encoded with a data structure. The data structure includes information identifying a group of tasks associated with at least one job position. The group includes at least one task. The data structure also includes, for each task in the group, information identifying at least one of a skill and an ability associated with the task. Further, the data structure includes, for each skill and ability, information identifying at least one of a unique attribute and a behavior associated with the skill or ability. In addition, the data structure includes information identifying at least one additional characteristic associated with the group of tasks. The at least one additional characteristic includes one or more of a unique knowledge, a tool, a software application, a device, a resource, and a personal trait associated with the group of tasks.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example system for defining occupational-specific skills associated with job positions according to one embodiment of this disclosure;

FIG. 2 illustrates an example skill object used to define occupational-specific skills associated with job positions according to one embodiment of this disclosure;

FIG. 3 illustrates an example association of skill objects defining occupational-specific skills with a job position according to one embodiment of this disclosure;

FIG. 4 illustrates an example method for creating skill objects used to define occupational-specific skills associated with job positions according to one embodiment of this disclosure;

FIG. 5 illustrates an example method for human resources management using skill objects according to one embodiment of this disclosure; and

FIG. 6 illustrates an example method for using skill objects associated with job positions according to one embodiment of this disclosure.

### DETAILED DESCRIPTION OF EXAMPLE EMBODIMENTS

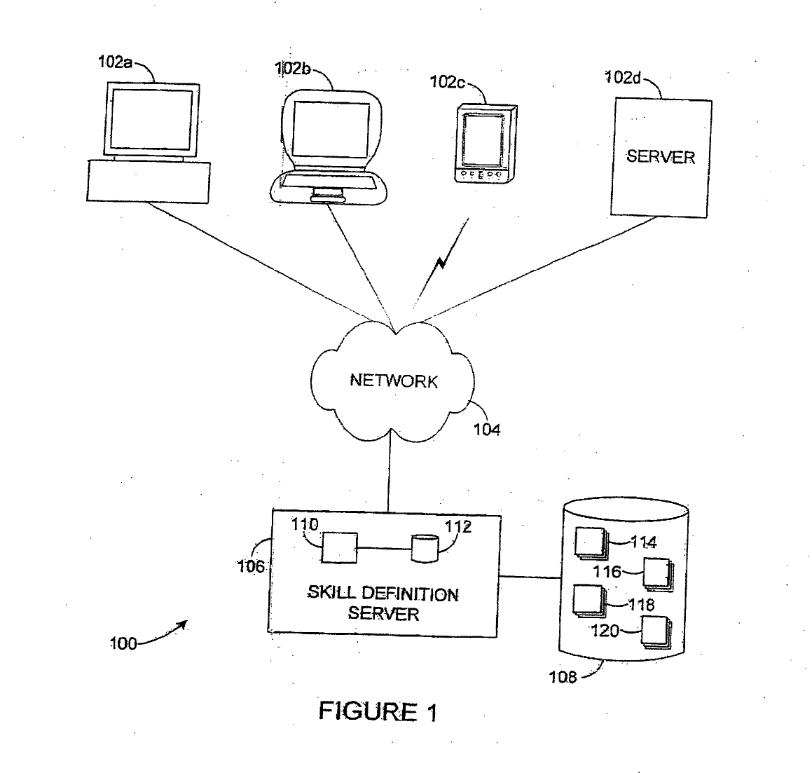

FIG. 1 illustrates an example system 100 for defining occupational-specific skills associated with job positions according to one embodiment of this disclosure. In the illustrated example, the system 100 includes multiple user devices 102a-102d, a network 104, a skill definition server 106, and a database 108. Other embodiments of the system 100 may be used without departing from the scope of this disclosure.

In one aspect of operation, one or more users use the user devices 102a-102d (referred to as “user devices 102”) to access the skill definition server 106. Using information from the users, the skill definition server 106 generates one or more objects defining one or more skills. The skills that are important for a particular job may then be associated with one another. In this way, the required skills for a particular job may be identified by an employer. Also, an employer may determine whether a particular job applicant has the skills required for a particular job opening. Further, a job applicant's skills may be matched with job openings or used to identify potential occupations for the applicant. In addition, trainers and educators may identify skills for which training may be useful for a particular employer, a group of employers, or an entire industry.

In the illustrated embodiment, each user device 102 is capable of communicating with the network 104. In this document, the term “each” refers to each of at least a subset of the identified items. Each user device 102 represents any suitable device, system, or portion thereof that allows a user to communicate and interact with the skill definition server 106. For example, a user device 102 may allow a user to access the skill definition server 106 and define various skills. The user device 102 may also allow the user to identify various skills needed for particular job positions.

In this particular example, the user devices 102 include a desktop computer, a laptop computer, a personal digital assistant, and a server computer. Each of these user devices 102 communicates over a wireline or wireless connection. These user devices 102 are for illustration only. Any other or additional computing or communication devices may be used in the system 100. Each user device 102 includes any hardware, software, firmware, or combination thereof for accessing the skill definition server 106.

The network 104 is capable of communicating with the user devices 102 and the skill definition server 106. The network 104 facilitates communication between components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The skill definition server 106 is coupled to the network 104 and the database 108. In this document, the term “couple” and its derivatives refer to any direct or indirect communication between two or more elements, whether or not those elements are in physical contact with one another. The skill definition server 106 supports the definition of various skills and the association of those skills with various job positions. For example, the skill definition server 106 allows users to create objects defining particular skills, such as occupational-specific skills. In some embodiments, an object defining an occupational-specific skill is referred to as a “skill object” and includes a name of the skill and one or more tasks associated with the skill. A skill object may also identify unique knowledge, tools, software, devices, and resources associated with the skill. The skill definition server 106 further allows users to associate one or more skill objects with a job position or employee.

The skill definition server 106 includes any hardware, software, firmware, or combination thereof for defining skills and/or associating skills with job positions. As a particular example, the skill definition server 106 could include one or more processors 110 and one or more memories 112 containing data and instructions used by the one or more processors 110. Also, the skill definition server 106 may receive input from users in any suitable manner, such as through the use of a web-based interface.

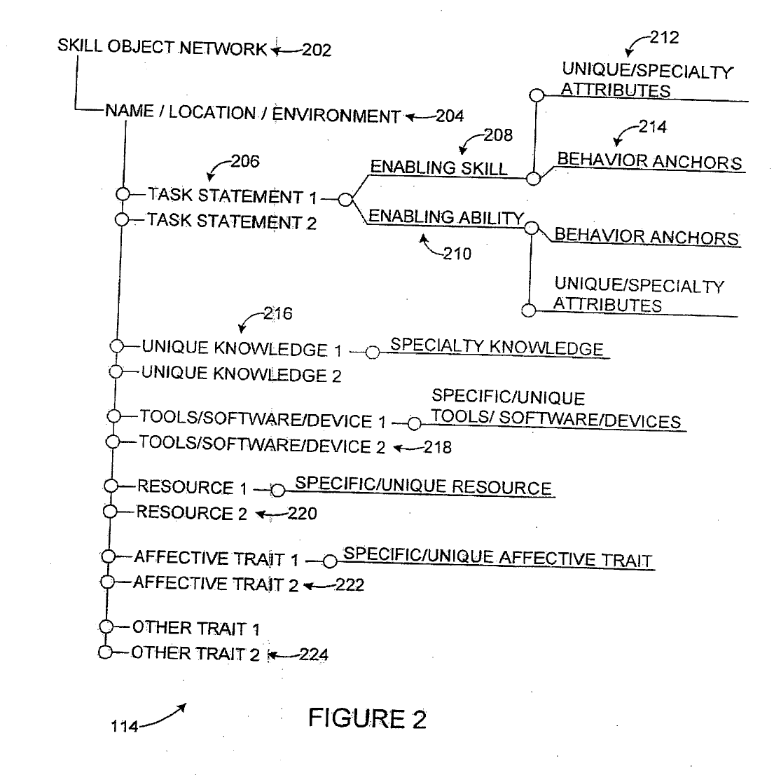

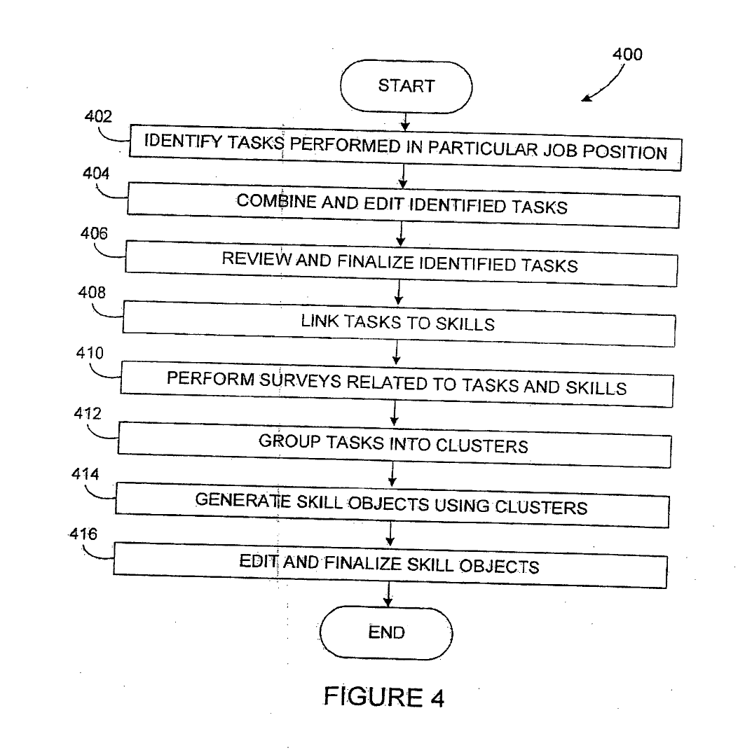

The database 108 is coupled to the skill definition server 106. The database 108 stores various information used by the skill definition server 106 to define skills and/or associate skills with job positions. For example, the database 108 includes one or more skill objects 114. The skill objects 114 represent the various objects created by the skill definition server 106 with input from users using the devices 102. One example of a skill object 114 is shown in FIG. 2, which is described below. One example of a method for generating a skill object 114 is shown in FIG. 4, which is described below.

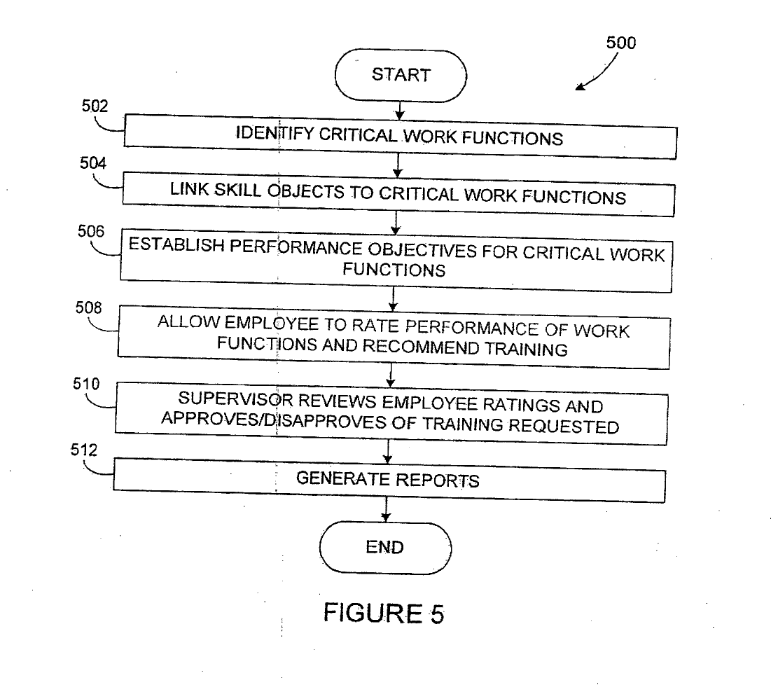

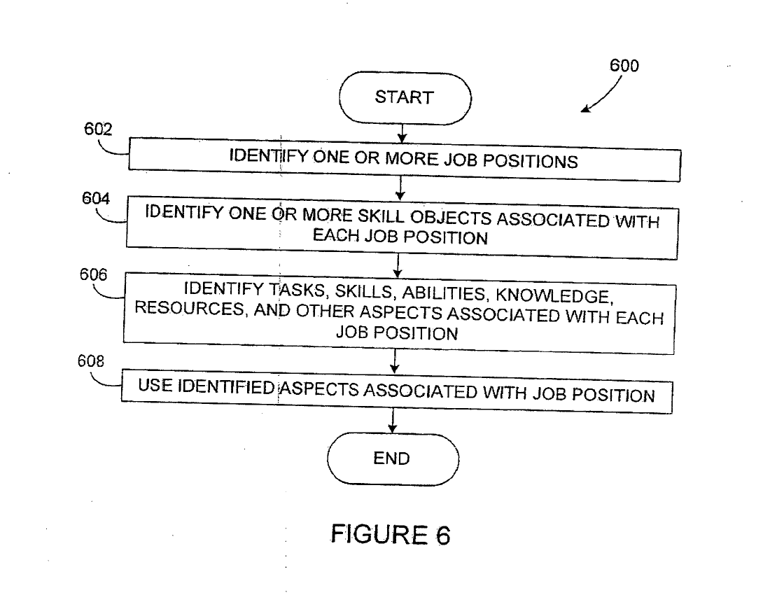

In this example, the database 108 also identifies one or more work functions 116, one or more job records 118, and one or more associations 120. The work functions 116 identify general functions that are typically performed by employees in one or more job positions. The job records 118 identify various job positions in one or multiple organizations. The associations 120 identify various relationships between the skill objects 114, the work functions 116, and the job records 118. For example, the associations 120 may indicate that one or more skills represented by one or more skill objects 114 are needed to perform a work function 116. The associations may also indicate that one or more work functions 116 are performed in a job position represented by a job record 118. In this way, skills may be indirectly associated with job positions through the work functions. An example association involving the skill objects 114 is shown in FIG. 4, which is described below. Example methods for using the skill objects 114 are shown in FIGS. 5 and 6, which are also described below.

The database 108 includes any hardware, software, firmware, or combination thereof for storing and facilitating retrieval of information. The database 108 also uses any of a variety of data structures, arrangements, and compilations to store and facilitate retrieval of information.

Although FIG. 1 illustrates one example of a system 100 for defining occupational-specific skills associated with job positions, various changes may be made to FIG. 1. For example, the system 100 may include any number of user devices 102, networks 104, servers 106, and databases 108. Also, while FIG. 1 illustrates the use of a server 106 in the system 100, the functionality of the server 106 could be implemented on other device(s). As a particular example, the functionality of the server 106 could be implemented as a stand-alone application on a desktop computer or a laptop computer. In addition, while FIG. 1 illustrates that one database 108 is coupled directly to the skill definition server 106, any number of databases 108 may reside at any location or locations accessible by the server 106.

FIG. 2 illustrates an example skill object 114 used to define occupational-specific skills associated with job positions according to one embodiment of this disclosure. The skill object 114 may be created and used, for example, by the skill definition server 106 in the system 100 of FIG. 1. The skill object 114 shown in FIG. 2 is for illustration only. Other embodiments of the skill object 114 may be used in the system 100 of FIG. 1 or in any other suitable system without departing from the scope of this disclosure.

As shown in FIG. 2, a collection of skill objects 114 is referred to as a skill object network 202. The skill object network 202 may include any suitable number of skill objects 114. Also, the skill objects 114 in a skill object network 202 may be associated with any number of organizations such as businesses or other employers. For example, the skill objects 114 in a skill object network 202 may be associated with a single organization, a group of organizations such as businesses in a single industry, or with multiple organizations in multiple industries.

Each skill object 114 has an associated name 204. The name 204 uniquely identifies each skill object 114. In some embodiments, the name 204 is specific to the work that is performed using this skill. For example, the skill object 114 could be named “System Backup” and relate to the backup of a computer system. In this example, the name 204 may also include a location and/or an environment. The location and environment allow multiple skill objects 114 for the same skill to be defined, where the multiple skill objects 114 are associated with different locations and work environments. This may allow, for example, unique skill objects 114 to be defined for a skill that is performed in different facilities in different geographic locations. This may also allow unique skill objects 114 to be defined for a skill that is performed in different work environments, such as when a skill is used with different computer operating systems.

Each skill object 114 also includes one or more task statements 206. In general, the task statements 206 identify discrete actions or portions of work that are performed as part of the skill associated with the skill object 114. For example, the task statements 206 may identify one or more actions that are typically performed, evaluated, and/or learned in a similar manner. As a particular example, the “System Backup” skill object 114 could include task statements 206 such as “Activate System Backup Software,” “Monitor Indicators,” and “Respond to Problematic Indicators.”

Each task statement 206 includes or otherwise identifies a primary or enabling skill 208 and a primary or enabling ability 210. The enabling skill 208 identifies a general skill that is associated with the task statement 206. In some embodiments, the enabling skill 208 is very high-level or general. Example enabling skills 208 may include “Reading,” “Writing,” or “System Administration.” Similarly, the enabling ability 210 identifies a general ability needed to perform the action in the task statement 206. In some embodiments, the enabling ability 210 is also very high-level or general. Example enabling abilities 210 may include “Touch Typing” and “Data Organization.” In particular embodiments, the enabling skills 208 and the enabling abilities 210 for all task statements 206 are selected from a list of standard enabling skills and a list of standard enabling abilities, respectively. Although FIG. 2 illustrates a single enabling skill 208 and a single enabling ability 210, additional skills and abilities (such as secondary skills and abilities) could also be identified.

Each of the enabling skills 208 and the enabling abilities 210 is associated with one or more unique or specialty attributes 212 and one or more behavior anchors 214. The unique or specialty attributes 212 identify one or more unique characteristics associated with a specific enabling skill 208 or enabling ability 210. For example, the unique or specialty attributes 212 associated with the “Touch Typing” enabling skill 210 may identify the typing speed required for a particular job position or the ability to transcribe conversations from audio tapes. The behavior anchors 214 identify one or more behaviors that are associated with the enabling skill 208 or enabling ability 210. For example, the behavior anchors 214 associated with the “Data Organization” enabling ability 210 may indicate that a strong attention to detail is required for a particular job position.

Each skill object 114 further identifies one or more unique knowledges 216. Each unique knowledge 216 identifies a knowledge needed to perform the skill represented by a skill object 114. For example, the “System Backup” skill object 114 could include unique knowledges 216 such as knowledge of corporate policies regarding system backups, knowledge about different computer viruses, and knowledge about how backup software, operating systems, and platforms function.

Each skill object 114 also identifies one or more tools, software, or devices 218 and one or more resources 220. Each of the tools, software, or devices 218 identifies a tool, software, or device used to perform the skill represented by a skill object 114. Similarly, each of the resources 220 identifies a resource used to perform the skill represented by a skill object 114. Example tools, software, or devices 218 may include spreadsheets, word processors, and other electronic applications used in a job position. Example tools, software, or devices 218 could also include mass spectrometers, computer hardware, and other devices used in a job position. Example resources 220 could include familiarity with a particular product's manual or familiarity with any other resource used in a job position.

In addition, each skill object 114 identifies one or more affective traits 222. The affective traits 222 identify various personality traits or other personal characteristics typically needed to perform the skill represented by a skill object 114. Example affective traits 222 could include trustworthiness, honesty, and reliability. Some of these traits may be more important than others, depending on the skill.

The skill object 114 may be expanded according to particular needs. For example, the use of other traits 224 allows a particular skill object 114 or set of skill objects 114 to be expanded to include other information as needed.

In some embodiments, some of the elements 206, 216-224 in a skill object 114 may be more important than other elements. For example, the possession of a particular unique knowledge 216 may be more important than knowledge of a particular tool, software, or device 218. To take this into account, some or all of the elements 206, 216-224 in the skill object 114 may be assigned weights or other importance values. As an example, weights may be assigned to the elements 206, 216-224 such that the weights sum to a value of one hundred. Through the use of the weights, the skill object 114 may describe multiple aspects of a job position and the relative importance of each of those aspects.

In particular embodiments, each of the elements 206, 216-224 in the skill object 114 may also be rated or ranked according to one or more criteria. For example, each of the elements 206, 216-224 could be rated in terms of the importance or criticality of each element to the performance of the skill. Each of the elements 206, 216-224 could also be rated in terms of the frequency and duration of use of each element during the performance of the skill. Each of the elements 206, 216-224 could further be rated on its difficulty to learn and its latency. Each of the elements 206, 216-224 could be rated according to any other or additional terms, including the average proficiency at using the element when needed. The elements could be ranked in any suitable manner, such as using five-point scales.

Multiple skill objects 114 may be stored in a relational or other database, such as the database 108 in the system 100 of FIG. 1. The elements of the skill objects 114 may then be related and used in any suitable manner. For example, the skill objects 114 may be associated with particular job positions, which allows an employer to quickly identify the skills required for a particular job. Also, an employer may determine whether a job applicant has the skills required for a job opening, and a job applicant's skills may be matched with job openings. Further, the employer could identify when its employees lack certain skills and schedule training for some or all of the employees. In addition, the skills of employees in different geographic regions may be compared, which may allow an employer to route particular work or decisions to regions having employees with the appropriate skills.

As another example, when a business or other employer considers entering a new market, the skills of the employer's employees may be compared to the skills needed in the new market. In this way, the employer could determine whether it has the necessary expertise to be successful in the new market. This also allows the employer to identify the training that may be required for entry into the new market. In addition, the employer could identify the training costs and other costs that may be required for the employees to gain the required skills needed for entry into the new market.

As still another example, an organization may wish to combine two job positions, and the skill objects 114 associated with those job positions may be combined. The combined skill objects 114 may then be used to identify the skills and other qualifications needed to fill the new job position. This represents only several examples of the various ways in which the skill objects 114 may be used. The skill objects 114 may be used in any other suitable manner without departing from the scope of this disclosure.

Although FIG. 2 illustrates one example of a skill object 114 used to define occupational-specific skills associated with job positions, various changes may be made to FIG. 2. For example, a skill object 114 could include a subset of the identified elements. Also, a skill object 114 could include any other or additional elements.

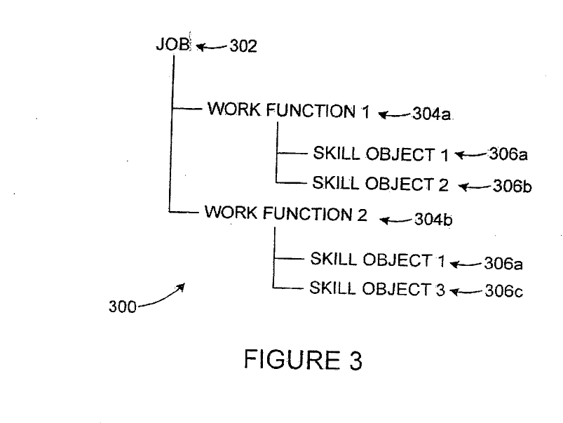

FIG. 3 illustrates an example association 300 of skill objects defining occupational-specific skills with a job position according to one embodiment of this disclosure. The association 300 may be created and used, for example, by the skill definition server 106 in the system 100 of FIG. 1. The association 300 shown in FIG. 3 is for illustration only. Other associations may be used in the system 100 of FIG. 1 or in any other suitable system without departing from the scope of this disclosure.

As shown in FIG. 3, the association 300 includes a job identifier 302. The job identifier 302 identifies a job position in one or multiple organizations. As a particular example, the job identifier 302 may identify or be associated with one of the job records 118 in the database 108, where that job record 118 identifies a job position.

The association 300 also includes one or more work function identifiers 304a-304b. The work function identifiers 304a-304b identify one or more work functions that are associated with the job position identified by the job identifier 302. As a particular example, the work function identifiers 304a-304b may identify or be associated with one or more of the work functions 116 in the database 108.

The association 300 further includes one or more skill object identifiers 306a-306c, where each of the skill object identifiers 306a-306c is associated with one or more of the work function identifiers 304a-304b. The skill object identifiers 306a-306c identify one or more skills associated with the work functions. As a particular example, the skill object identifiers 306a-306c may identify or be associated with one or more of the skill objects 114 in the database 108.

In effect, the association 300 identifies the various work functions typically performed by an employee in a given job position and the skills that are typically needed for each of those work functions. The association 300 may be generated in any suitable manner. For example, as described below, one or more people (such as experts or other employees) may provide information about skills to the skill definition server 106, which uses the information to generate the skill objects 114. Similarly, using information from these people, the skill definition server 106 may also generate one or more work functions 116 and one or more job records 118. In addition, the skill definition server 106 may receive information associating the work functions 116 with the job records 118 and associating the skill objects 114 with the work functions 116. The association information may be stored in the database 108 as associations 120.

Although FIG. 3 illustrates one example of an association 300 of skill objects defining occupational-specific skills with a job position, various changes may be made to FIG. 3. For example, in this example, the job position is associated with two work function identifiers 304a-304b, and each of the work function identifiers 304a-304b is associated with two of the skill object identifiers 306a-306c. Also, the same skill object identifier 306a is shown as being associated with both of the work function identifiers 304a-304b. A job position may be associated with any number of work function identifiers, and each of the work function identifiers may be associated with any number of skill object identifiers. Moreover, each of the skill object identifiers may be associated with one, some, or all of the work function identifiers.

FIG. 4 illustrates an example method 400 for creating skill objects used to define occupational-specific skills associated with job positions according to one embodiment of this disclosure. For ease of explanation, the method 400 is described with respect to the system 100 of FIG. 1. The method 400 could be used in any other suitable, system. Also, various steps in the method 400 could be performed by the skill definition server 106 or performed manually or otherwise without interaction with the skill definition server 106.

One or more tasks performed in a particular job position are identified at step 402. This may include, for example, one or more experts or high performance employees who hold or have held the job position identifying the tasks. Any number of people may be involved in this step, such as one, two, four, or twelve people. Also, the one or more people involved may start by identifying a similar job position already associated with one or more tasks and then adding, deleting, and modifying the tasks as needed. The one or more identified tasks could be provided electronically to the skill definition server 106, generated in written form, or provided in any other suitable manner.

The one or more identified tasks are combined and edited at step 404. This may include, for example, one or more skill analysts combining the tasks identified by different people during step 402, determining which tasks are relevant and which tasks are not, and producing a single set of tasks.

The single set of tasks are then reviewed and finalized at step 406. This may include, for example, one or more reviewers making additional recommendations for adding, deleting, or modifying tasks in the single set of tasks.

The tasks in the finalized set of tasks are each linked to a skill and an ability at step 408. This may include, for example, a skill analyst or other person identifying an enabling skill 208 and an enabling ability 210 for each of the tasks. In particular embodiments, the enabling skill 208 and the enabling ability 210 are selected from a standardized list of skills and a standardized list of abilities.

One or more surveys are performed at step 410. This may include, for example, performing a survey asking employees to rate different aspects of the tasks contained in the finalized list. In particular, the survey could ask the employees to rate the criticality of each task, the frequency of using each task, the difficulty in learning each task, and their proficiency at performing each task when needed. This may also include performing a survey asking the employees to identify the skills used by the employees in their various job positions. Other or additional surveys, such as ability surveys, truth surveys, and unique data surveys, could also be performed.

The tasks in the finalized set are grouped into related clusters at step 412. This may include, for example, one or more experts or high performance employees grouping the tasks into clusters of tasks that are performed, evaluated, and/or learned in a similar manner. This may also include the one or more experts or high performance employees identifying unique knowledges, tools, devices, software, resources, and traits that are important for or otherwise associated with each cluster of tasks.

One or more skill objects 114 are generated at step 414. This may include, for example, the skill definition server 106 generating a data object for each cluster of tasks. This may also include the skill definition server 106 inserting an object name and one of the clusters of tasks into each data object. This may further include the skill definition server 106 inserting the unique knowledges, tools, devices, software, resources, and traits associated with each cluster of tasks into the data objects.

The one or more skill objects 114 are reviewed, edited, and finalized at step 416. This may include, for example, a reviewer adding, editing, or deleting various unique knowledges, tools, devices, software, resources, and traits in the skill objects 114. This may also include the reviewer editing the names of the skill objects 114.

At this point, the skill objects 114 may be used in any suitable manner. For example, the skill objects 114 may be associated with the particular job position to identify the skills required for that job. The skill objects 114 could also be used to identify an employer's strengths and weaknesses or in any other suitable manner.

Although FIG. 4 illustrates one example of a method 400 for creating skill objects 114 used to define occupational-specific skills associated with job positions, various changes may be made to FIG. 4. For example, the skill survey could be optional. Also, the various steps may be performed in any suitable manner. As examples, the information generated and/or collected in the various steps could be provided to the skill definition server 106 by users using the user devices 102. At least some of the information could also be generated automatically by the skill definition server 106, such as when business rules are used to generate the various fields of the skill object 114. In addition, at least some of the information could be produced and exchanged in printed or electronic form without the involvement of the skill definition server 106.

FIG. 5 illustrates an example method 500 for human resources management using skill objects 114 according to one embodiment of this disclosure. For ease of explanation, the method 500 is described with respect to the system 100 of FIG. 1. The method 500 could be used in any other suitable system. Also, various steps in the method 500 could be performed by the skill definition server 106 or manually or otherwise without interaction with the skill definition server 106.

One or more work functions associated with a particular job position are identified at step 502. This may include, for example, a manager of the job position identifying the critical or most important functions performed by an employee in a job position.

One or more skill objects 114 are linked to each of the identified work functions at step 504. This may include, for example, one or more experts, high performance employees, or managers identifying the skill objects 114 associated with tasks performed during the work functions. This may also include associating the identified skill objects 114 with the identified work functions. Each skill object 114 may be associated with one or multiple work functions.

At this point, the skill objects 114 are associated with the work functions, and the work functions may be associated with one or more job positions. In this way, the skills needed for a particular job position may be determined by identifying the work functions for that job position and identifying the skill objects 114 associated with those work functions.

In the illustrated example, the skill objects 114 are used to rate employee performance and identify necessary training. In this example, one or more performance objectives are established for each of the work functions at step 506. This may include, for example, a manager identifying two or three performance objectives for each work function associated with a particular job position.

An employee is allowed to rate his or her performance for each of the work functions at step 508. This may include, for example, the employee rating his or her performance of each task associated with each of the work functions. This may also include the employee identifying any training that the employee believes is necessary to help improve the employee's ratings.

A supervisor reviews the employee's ratings and recommended training at step 510. This may include, for example, the supervisor agreeing or disagreeing with the employee's ratings. This may also include the supervisor approving or disapproving of the employee's requests for training.

One or more reports are generated at step 512. This may include, for example, the skill definition server 106 generating reports containing information from the skill objects 114, the employee's ratings, and the supervisor's approvals and disapprovals. This may also include generating a report identifying the type of training needed for one or more employees. Any other or additional reports could also be generated.

Although FIG. 5 illustrates one example of a method 500 for human resources management using skill objects 114, various changes may be made to FIG. 5. For example, the first two steps 502-504 may be performed to link the skill objects 114 to different job positions, and the skill objects 114 may then be used in any other suitable manner. Also, the skill objects 114 could be associated with job positions without using work functions. In addition, the various steps may be performed in any suitable manner.

FIG. 6 illustrates an example method 600 for using skill objects 114 associated with job positions according to one embodiment of this disclosure. For ease of explanation, the method 600 is described with respect to the system 100 of FIG. 1. The method 600 could be used in any other suitable system.

The skill definition server 106 identifies one or more job positions at step 602. This may include, for example, the skill definition server 106 receiving an identification of one or more job positions from a user using a device 102.

The skill definition server 106 identifies one or more skill objects 114 associated with each of the identified job positions at step 604. This may include, for example, the skill definition server 106 identifying one or more work functions associated with each job position. This may also include the skill definition server 106 identifying one or more skill objects 114 associated with each of the identified work functions.

The skill definition server 106 identifies one or more tasks, skills, abilities, knowledge, resources, and other aspects associated with each of the job positions at step 606. This may include, for example, the skill definition server 106 retrieving the various aspects of the job positions from the identified skill objects 114.

The identified tasks, skills, abilities, knowledge, resources, and other aspects associated with the job positions are used to perform any suitable function or functions at step 608. For example, the identified aspects of the job positions may be compared with the qualification of a job applicant to identify positions for which the applicant is qualified. The identified aspects could also be used to identify skills for which training is needed for a particular employee, for a group of employees, or for an entire organization. Further, the skill objects 114 could be divided by geographic location, and the skills and abilities of employees in different locations may be used to route particular work or decisions to particular regions. In addition, the identified aspects could be used to determine whether an employer has employees with the skills needed so the employer can enter a particular market.

Although FIG. 6 illustrates one example of a method 600 for using skill objects 114 associated with job positions, various changes may be made to FIG. 6. For example, the contents of the skill objects 114 could be used in any other suitable manner.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
identifying a plurality of tasks associated with at least one type of work;
grouping the plurality of tasks into one or more groups, each group comprising at least one of the identified tasks;
for each of the one or more groups, identifying at least one additional characteristic associated with the group; and
for each of the one or more groups, storing information identifying the at least one task associated with the group and the at least one additional characteristic associated with the group in a data object.

2. The method of claim 1, further comprising identifying at least one of: one or more skills and one or more abilities associated with the tasks.

3. The method of claim 2, wherein the identifying at least one of the skills and the abilities comprises:
selecting at least one of the skills and the abilities from at least one of: a list of skills and a list of abilities.

4. The method of claim 2, further comprising identifying at least one of: one or more unique attributes and one or more behaviors associated with the skills and abilities.

5. The method of claim 1, wherein the at least one additional characteristic comprises one or more of: a unique knowledge, a tool, a software application, a device, a resource, and a personal trait associated with at least one of the groups.

6. The method of claim 1, wherein at least one of the at least one task and the at least one additional characteristic in each data object may be assigned a weight.

7. The method of claim 6, wherein:
data objects storing information associated with a plurality of job positions are created;
the data objects identify the same tasks and the same at least one additional characteristic;
the data objects contain a same or similar weights for the tasks and the at least one additional characteristic; and
the data objects contain different weights for the tasks and the at least one additional characteristic.

8. The method of claim 1, further comprising storing ratings or rankings in each data object for at least one of: the tasks and the at least one additional characteristic.

9. The method of claim 8, wherein each rating or ranking defines at least one of: a difficulty in learning one of the tasks or additional characteristics, a duration of using one of the tasks or additional characteristics, a frequency of using one of the tasks or additional characteristics, another ranking, and an importance of using one of the tasks or additional characteristics in the job position.

10. The method of claim 1, further comprising associating each data object with the job position.

11. The method of claim 10, further comprising using the data objects associated with the type of work to determine if a job applicant is qualified for the type of work.

12. The method of claim 10, wherein a plurality of job positions are associated with a plurality of data objects; and
further comprising using the data objects associated with the job positions to identify at least one of: one or more job positions and one or more occupations for which an individual is qualified.

13. The method of claim 10, further comprising using the data objects associated with the job position to identify training for at least one individual.

14. The method of claim 10, wherein a plurality of job positions are associated with a plurality of data objects, the plurality of job positions associated with different geographical locations or systems; and
further comprising using the data objects associated with the job positions to identify at least one of: a specific geographic location or system to receive work and a specific geographic location or system to make a decision.

15. The method of claim 10, wherein a plurality of job positions are associated with a plurality of data objects; and
further comprising using the data objects associated with the job positions to:
determine if an organization possesses skills in a market; and
identify at least one of training and a cost of training if the organization does not possess the skills.

16. The method of claim 1, wherein grouping the plurality of tasks into the one or more groups comprises:
grouping into a group two or more tasks that are at least one of performed, evaluated, and learned in a similar manner.

17. The method of claim 1, wherein the data object comprises one of a plurality of data objects; and
further comprising:
associating the plurality of data objects with a plurality of work functions; and
associating the plurality of work functions with a plurality of job positions.

18. A system, comprising:
a memory operable to store one or more data objects; and
one or more processors operable to:
store information identifying a group of tasks associated with at least one type of work in each of the data objects, each group comprising at least one task; and
store information identifying at least one additional characteristic associated with the group of tasks in each of the data objects.

19. The system of claim 18, wherein the one or more processors are further operable to store, in each data object, information identifying at least one of: one or more skills and one or more abilities associated with the group of tasks in the data object.

20. The system of claim 19, wherein the one or more processors are further operable to:
provide to a user at least one of: a list of skills and a list of abilities that are associated with at least one of the tasks; and
receive a user's selection of at least one of: one or more skills and one or more abilities from the list.

21. The system of claim 20, wherein the one or more processors are further collectively operable to store, in each data object, information identifying at least one of: one or more unique attributes and one or more behaviors associated with the skills and abilities.

22. The system of claim 18, wherein the at least one additional characteristic comprises one or more of: a unique knowledge, a tool, a software application, a device, a resource, and a personal trait associated with at least one of the groups.

23. The system of claim 18, wherein the one or more processors are operable to receive and store, in each data object, a weight for each task and additional characteristic associated with the data object.

24. The system of claim 18, wherein the one or more processors are operable to receive and store, in each data object, one or more ratings or rankings for each task and additional characteristic associated with the data object.

25. The system of claim 24, wherein each rating or ranking defines one of: a difficulty in learning one of the tasks or additional characteristics, a duration of using one of the tasks or additional characteristics, a frequency of using one of the tasks or additional characteristics, and an importance of using one of the tasks or additional characteristics in the type of work.

26. The system of claim 18, wherein the one or more processors are operable to associate each data object with the type of work.

27. The system of claim 26, wherein the one or more processors are operable to at least one of:
use the data objects associated with the type of work to determine if an individual is qualified for the type of work; and
use the data objects associated with the type of work to identify training for at least the individual.

28. The system of claim 26, wherein:
a plurality of types of work are associated with a plurality of data objects; and
the one or more processors are further collectively operable to at least one of:
use the data objects associated with the types of work to identify at least one of: one or more types of work and one or more occupations for which an individual is qualified;
use the data objects associated with the types of work to identify at least one of: a specific geographic location or system to receive particular work and a specific geographic location or system to make a particular decision; and
use the data objects associated with the types of work to determine if an organization possesses required skills needed to be successful in a particular market and to identify at least one of training and a cost of training if the organization does not possess the required skills.

29. The system of claim 18, wherein the data object comprises one of a plurality of data objects; and
the one or more processors are operable to:
associate the plurality of data objects with a plurality of work functions; and
associate the plurality of work functions with a plurality of job positions.

30. The system of claim 20, wherein the at least one task is related to a data object.

31. The system of claim 20, wherein the one or more processors are further operable to provide to a user at least one of: a list of tasks, a list of tools, a list of data objects, a list of data object characteristics, a list of groups, a list of work, a list of work functions, and a list of job positions.

32. The system of claim 1, wherein the one or more processors are further collectively operable to store, in each data object, information identifying at least one of: one or more specialty knowledge, one or more unique tools, one or more unique software, one or more unique devices, one or more unique resources, and one or more unique affective traits.

33. The system of claim 32, wherein the one or more specialty knowledge is associated with a unique knowledge, wherein the one or more unique tools are associated with tools, wherein the one or more unique software are associated with software, wherein the one or more unique devices are associated with devices, wherein the one or more unique resources are associated with devices, and wherein the one or more unique affective traits are associated with affective traits.

34. A computer program embodied on a computer readable medium and operable to be executed by at least one processor, the computer program comprising computer readable program code for:
receiving an identification of one or more groups of tasks associated with at least one type of work, each group comprising at least one task;
receiving, for each of the one or more groups, an identification of at least one additional characteristic associated with the group; and
storing, for each of the one or more groups, information identifying the at least one task and the at least one additional characteristic associated with the group in a data object.

35. The computer program of claim 34, further comprising computer readable program code for at least one of:
using the data objects associated with a type of work to determine if an individual is qualified for the type of work;
using the data objects associated with a type of work to identify training for at least the individual;
using the data objects associated with multiple types of work to identify at least one of: one or more types of work and one or more occupations for which an individual is qualified;
using the data objects associated with multiple types of work to identify at least one of: a specific geographic location to receive particular work and a specific geographic location to make a particular decision; and
using the data objects associated with multiple types of work to determine if an organization possesses required skills needed to be successful in a particular market and to identify at least one of training and a cost of training if the organization does not possess the required skills.

36. The computer program of claim 34, wherein:
the data object comprises one of a plurality of data objects; and
the computer program further comprises computer readable program code for:
associating the plurality of data objects with a plurality of work functions; and
associating the plurality of work functions with a plurality of types of work.

37. A computer readable medium encoded with a data structure, the data structure comprising:
information identifying a group of tasks associated with at least one type of work, the group comprising at least one task;
for each task in the group, information identifying at least one of: a skill and an ability associated with the task;
for each skill and ability, information identifying at least one of: a unique attribute and a behavior associated with the skill or ability; and
information identifying at least one additional characteristic associated with the group of tasks, wherein the at least one additional characteristic comprises one or more of: a unique knowledge, a tool, a software application, a device, a resource, and a personal trait associated with the group of tasks.
